(19) United States
(12) Patent Application Publication
(10) Pub. No.: US 2008/0223450 A1
(43) Pub. Date: Sep. 18, 2008

(54) FLOW CONTROL VALVES

(75) Inventors: Hisashi KINO, Kariya-shi (JP); Tomiharu ISOGAI, Hekinan-shi (JP); Yasuhiro NISHIKAWA, Aichi-ken (JP); Masaru NAKAMURA, Ichinomiya-shi (JP); Hideki ASANO, Tokai-shi (JP); Hiroki SHIMADA, Anjo-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 12/041,070

(22) Filed: Mar. 3, 2008

(30) Foreign Application Priority Data
Mar. 15, 2007 (JP) 2007-066635
Jun. 11, 2007 (JP) 2007-153839

(51) Int. Cl. F16K 29/00

(52) U.S. Cl. 137/331

(57) ABSTRACT

A flow control valve includes a seal member disposed within an annular space. The annular space is defined between at least one of bearing fitting portions of a flow path defining member and a corresponding valve shaft portion of a valve member opposing to each other in a radial direction with respect to an axis of the valve shaft portion and between an end face of a corresponding bearing and an end face of a valve body portion opposing to each other in a direction of the axis. The seal member can seal between the bearing fitting portion and the corresponding valve shaft portion with respect to the radial direction and can also seal between the corresponding bearing and the valve body portion with respect to the axial direction.

This application claims priority to Japanese patent application serial numbers 2007-066635 and 2007-153839, the contents of which are incorporated herein by reference.

### BACKGROUND OF THE INVENTION

1. Field of the Invention

The present invention relates to flow control valves that are used primarily for controlling the flow of an intake air or an exhaust gas of an internal combustion engine.

2. Description of the Related Art

Japanese Laid-Open Utility Model Publication No. 6-18636 teaches a known flow control valve. As shown in FIG. 23, a flow control valve 100 of this publication includes a throttle chamber body 104 defining a cylindrical intake air channel 105. A throttle shaft 103 extends across the intake air channel 105 and has opposite ends respectively rotatably supported by opposite wall portions of the throttle chamber body 104 via bearings 107. A disk-like throttle valve 106 is attached to the central portion of the throttle shaft 103 in order to open and close the intake air channel 105. A seal member 117 is positioned on the side opposite to the intake air channel 105, i.e., the outer side, of each bearing 107. As the throttle shaft 103 rotates, the throttle valve 106 opens or closes the intake air channel 105 of the throttle chamber body 104, so that the flow rate of the intake air flowing through the intake air channel 105 can be controlled.

The outer diameter, i.e. a diameter called a valve diameter, of the throttle valve 106 is set to be smaller than the inner diameter, i.e., a diameter called a bore diameter, of the intake air channel 105. This setting is for preventing degradation in movability of the throttle valve 106 due to frictional contact of the throttle valve 106 with the inner wall of the intake air channel 105. Therefore, a clearance may be formed between the throttle valve 106 and face portions of the inner wall opposing to the throttle valve 106 in the axial direction of the throttle shaft 103 (right and left directions as viewed in FIG. 23), i.e., portions of the inner wall of that intake air channel 105 about the throttle shaft 103. This results in a problem that the intake air on the upstream side of the throttle valve 106 may leak toward the downstream side of the throttle valve 106 via the axial clearance. Such leakage of the intake air (hereinafter called “intake air leakage”) may cause increase in an idling speed of the internal combustion engine in particular when the throttle valve 106 is in a fully closed position. In this specification the term “fully closed position” is used to mean the fully closed position of the throttle valve 106 unless otherwise noted.

In addition, with the known flow control valve 110, the seal member 117 of each bearing 107 is positioned on the outer side of the corresponding bearing 107. Therefore, the seal member 117 may not serve to prevent the intake air leakage toward the downstream side of the intake air channel 105 when in the fully closed position. Although it may be possible to incorporate additional sealing members for preventing the intake air leakage when in the fully closed position, this measure is not preferable because the number of parts and the assembling steps may increase.

Therefore, there has been a need for flow control valves that can prevent the intake air leakage when in a full closed position without increase in the number of parts and the assembling steps.

### SUMMARY OF THE INVENTION

One aspect according to the present invention includes a flow control valve having a seal member disposed within an annular space. The annular space is defined between at least one of bearing fitting portion of a flow path defining member and a corresponding valve shaft portion of a valve body opposed to each other in a radial direction with respect to an axis of the valve shaft portion and between an end face of a corresponding bearing and an end face of the valve body opposing to each other in a direction of the axis. The seal member can seal between the bearing fitting portion and the corresponding valve shaft portion with respect to the radial direction and can also seal between the corresponding bearing and the valve body with respect to the axial direction.

### BRIEF DESCRIPTION OF THE DRAWINGS

FIG. 1 is a vertical sectional view of a throttle valve device according to a first embodiment of the present invention;

FIG. 2 is a horizontal sectional view of the throttle valve device;

FIG. 3 is a sectional view showing a sealing structure of the throttle valve device;

FIG. 4 is a front view of a seal member of the sealing structure shown in FIG. 4;

FIG. 5 is a cross sectional view taken along line V-V in FIG. 4;

FIG. 6 is a cross sectional view showing a sealing structure according to a second embodiment of the present invention:

FIG. 7 is a front view of a seal member of the sealing structure shown in FIG. 6;

FIG. 8 is a cross sectional view taken along line VIII-VIII in FIG. 7;

FIG. 9 is a cross sectional view showing a sealing structure according to a third embodiment of the present invention;

FIG. 10 is a front view of a seal member of the sealing structure shown in FIG. 9;

FIG. 11 is a cross sectional view taken along line XI-XI in FIG. 10;

FIG. 12 is a cross sectional view showing a sealing structure according to a fourth embodiment of the present invention;

FIG. 13 is a cross sectional view taken along line XIII-XIII in FIG. 12;

FIG. 14 is a front view of a seal member of the sealing structure shown in FIG. 12;

FIG. 15 is a cross sectional view taken along line XV-XV in FIG. 14;

FIG. 16 is a side view of the seal member;

FIG. 17 is a front view of a seal member of a sealing structure according to a fifth embodiment of the present invention;

FIG. 18 is a cross sectional view taken along line XVII-XVII in FIG. 17;

FIG. 19 is a side view of a part of the seal member;

FIG. 20 is a front view of a seal member according to a sixth embodiment of the present invention;

FIG. 21 is a cross sectional view taken along line XXI-XXI in FIG. 20;

FIG. 22 is a cross sectional view showing a sealing structure according to a seventh embodiment of the present invention;

FIG. 23 is a cross sectional view of a known flow control valve;

FIG. 24 is a cross sectional view showing a sealing structure according to an eighth embodiment of the present invention;

FIG. 25 is a cross sectional view of a seal member shown in FIG. 24;

FIG. 26 is a cross sectional view similar to FIG. 25 but showing a modification of the eighth embodiment;

FIG. 27 is a cross sectional view showing a sealing structure according to a ninth embodiment of the present invention:

FIG. 28 is a cross sectional view of a seal member shown in FIG. 27;

FIG. 29 is a cross sectional view similar to FIG. 28 but showing a modification of the ninth embodiment;

FIG. 30 is a cross sectional showing a sealing structure according to a tenth embodiment of the present invention;

FIG. 31 is a cross sectional view of a seal member shown in FIG. 30;

FIG. 32 is a cross sectional view similar to FIG. 31 but showing a modification of the tenth embodiment; and

FIG. 33 is a cross sectional view showing a sealing structure according to an eleventh embodiment of the present invention.

### DETAILED DESCRIPTION OF THE INVENTION

Each of the additional features and teachings disclosed above and below may be utilized separately or in conjunction with other features and teachings to provide improved flow control valves. Representative examples of the present invention, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a flow control valve includes a flow path defining member having a flow path defined therein, a pair of bearing fitting portions formed on the flow path defining member and each having an inner circumferential face, and a valve member including a pair of valve shaft portions and a valve body portion. Each of the valve shaft portions has an outer circumferential face and is rotatably supported by the corresponding bearing fitting portion via a bearing. The valve portion is rotatable with the valve shaft portions for opening or closing the flow path. An annular space is defined between the at least one of bearing fitting portions of a flow path defining member and a corresponding valve shaft portion of the valve member opposing to each other in a radial direction with respect to an axis of the valve shaft portion and between an end face of a corresponding bearing and an end face of the valve body portion opposing to each other in a direction of the axis. A seal member is disposed within the annular space and including a first seal portion configured to seal against the inner circumferential face of the at least one the bearing fitting portions, a second seal portion configured to seal against the outer circumferential face of the corresponding valve shaft portion, and a third seal portion configured to seal against the end face of the valve body portion.

With this arrangement, a single seal member can seal between the bearing fitting portion and the corresponding valve shaft portion with respect to the radial direction and can also seal between the corresponding bearing and the valve body portion with respect to the axial direction. Therefore, it is possible to prevent or minimize the potential leakage of a fluid to the outside of the flow path and to also prevent or minimize the potential leakage of the fluid from the upstream side to the downstream side of the valve member without accompanying increase in the number of parts or the number of assembling steps.

The seal member may be attached to the corresponding valve shaft portion of the valve body or the at least one of the bearing fitting portions of the flow path defining member. With this construction, it is possible to accurately position the seal member.

The seal member may be resiliently deformable and may be resiliently fitted to the corresponding valve shaft portion of the valve member or the at least one of the bearing fitting portions of the flow path defining member. An annular member may be attached to the seal member for restricting the resilient deformation with respect to the radial direction of the seal member. With this arrangement, it is possible to reliably fix the seal member in position relative to the corresponding valve shaft portion or the corresponding bearing fitting portion.

The annular member may have a contact part that can resiliently contact the outer circumferential face of the corresponding valve shaft portion or the inner circumferential face of the corresponding bearing fitting portion. With this arrangement, the seal member can be reliably positioned relative to the valve shaft portion or the bearing fitting portion with respect to the axial direction and a rotational direction about the axis. In particular, this positioning is effective to prevent a spring-back phenomenon of the seal member during the fitting operation of the seal member. The term “spring-back phenomenon” is use to mean a phenomenon causing the seal member to return to the direction opposite to the fitting direction due to the resiliency of the seal member when the seal member is fitted onto the valve shaft portion or the bearing fitting portion.

Preferably, the contact part may bite into or engage with the outer circumferential face of the corresponding valve shaft portion or the inner circumferential face of the corresponding bearing fitting portion, so that the seal member can be further reliably prevented from movement in the axial direction and from rotation about the axis.

The seal member may further include at least one of a positive-pressure receiving lip and a negative-pressure receiving lip. The positive-pressure receiving lip can resiliently deform to increase the contact pressure due to a positive pressure when the positive pressure is created within the flow path. The negative-pressure receiving lip can resiliently deform to increase the contact pressure due to a negative pressure when the negative pressure is created within the flow path. With this arrangement, it is possible to improve the sealing ability of the seal member when the positive pressure and/or the negative pressure has been created within the flow path.

The flow control valve may further include a second seal member positioned on the side of the corresponding bearing. The second seal member has a sealing portion for sealing against the inner circumferential face of the at least one bearing fitting portion and a sealing portion for sealing against the outer circumferential face of the valve shaft portion. With this arrangement, it is possible to further reliably seal between the bearing fitting portion and the valve shaft portion with respect to the radial direction. As a result, it is possible to further reliably prevent the potential leakage of a fluid to the outside of the flow path or the potential leakage of the fluid toward the downstream side of the valve member.

Also, the second seal member may include at least one of a positive-pressure receiving lip and a negative-pressure receiving lip. With this arrangement, it is possible to further improve the sealing ability when the positive pressure and/or the negative pressure has been created within the flow path.

The flow control valve may further include a slide member. The slide member is interleaved between the end face of the valve body portion and the seal portion that axially oppose to the end face of the valve body. The slide member slidably contacts the end face of the valve body portion. With this arrangement it is possible to prevent the seal portion from being worn or damaged due to the sliding contact with the end face of the valve body portion.

Preferably, the slide member is integrated with the seal member. Therefore, the slide member can be reliably positioned relative to the seal member.

In another embodiment, a seal member is disposed within the annular space and includes a press-fitting member and a resilient member. The press-fitting member is press-fitted to one of the inner circumferential face of the at least one bearing fitting portion and the outer circumferential face of the corresponding valve shaft portion. The resilient member includes a first seal portion for sealing against the end face of the valve body portion and a second seal portion for sealing against the other of the inner circumferential face of the at least one bearing fitting portion and the outer circumferential face of the corresponding valve shaft portion. The press-fitting member and the resilient member are integrated with each other.

Also with this arrangement, it is possible that a single seal member can seal between the bearing fitting portion and the corresponding valve shaft portion with respect to the radial direction and can also seal between the corresponding bearing and the valve body portion with respect to the axial direction.

The press-fitting member may include a contact part that can resiliently contact the one of the inner circumferential face of the at least one bearing fitting portion and the outer circumferential face of the corresponding valve shaft portion.

### First Embodiment

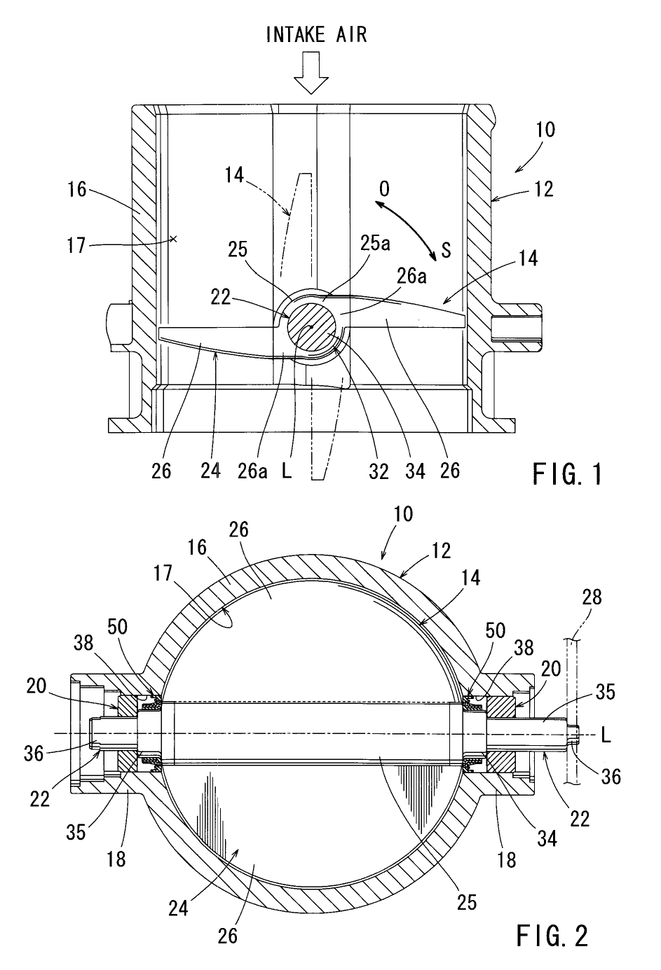

A first embodiment of the present invention will now be described with reference to FIGS. 1 and 2. Referring to FIGS. 1 and 2, a throttle valve device 10 generally includes a throttle body 12 and a throttle valve member 14.

The throttle body 12 may be made of resin and includes a hollow cylindrical bore wall portion 16. A bore 17 is defined within the bore wall portion 16 and serves as an intake air channel through which an intake air can flow. An air cleaner (not shown) may be connected to an upstream side (upper side as viewed in FIG. 1) of the bore wall portion 16. An intake manifold (not shown) may be connected to a downstream side (lower side as viewed in FIG. 1) of the bore wall portion 16. Therefore, as indicated by an arrow in FIG. 1, the intake air supplied from the air cleaner may flow vertically downward (as viewed in FIG. 1) through the bore 17 and may then be fed into the intake manifold. In this way, the throttle body 12 serves as a flow path defining member and the bore 17 may serve as a flow path through which the intake air as a fluid may flow.

As shown in FIG. 2, a pair of bearing fitting portions 18 are formed integrally with the bore wall portion 16 and are positioned on opposite sides of the bore wall portion 16. Each of the bearing fitting portions 18 has a hollow cylindrical configuration. The pair of bearing fitting portions 18 are positioned along an axis L that extends diametrically across the bore wall portion 16. The bearing fitting portions 18 respectively have inner ends on the side of the bore 17, which are joined to the bore wall portion 16, and extend on opposite sides to each other. The inner space defined within each of the bearing fitting portions 18 is in communication with the bore 17.

Referring to FIG. 2, the throttle valve member 14 may be made of resin and includes a pair of valve shaft portions 22 and a disk-like valve body portion 24. The valve shaft portions 22 are respectively rotatably supported by the bearing fitting portions 18 via bearings 20 that may be slide bearings. The valve body portion 24 can rotate with the valve shaft portions 22 for opening and closing the bore 17. The valve support portions 22 are positioned along the same axis. The valve body portion 24 has a substantially round rod-like support shaft portion 25 and a pair of semi-circular valve plate portions 25 formed on the support shaft portion 25 and are positioned symmetrically with respect to a point on the axis L. In FIG. 1, an upper face of the left side valve plate portion 26 and a lower face of the right side valve plate portion 26 are positioned within a plane extending across the axis L.

As shown in FIG. 2, each of the bearings 20 has a ring-like shape with an inner circumferential face, an outer circumferential face, an inner end face (on the side of the bore 17) and an outer end face and has a rectangular configuration in cross section. The inner end face and the outer end face are respectively configured as flat faces that are perpendicular to the axis L. Instead of ring-like shape, each of the bearings 20 may have a cylindrical shape. In this embodiment, the axial length of the bearing 20 on the right side as viewed in FIG. 2 is longer than the axial length of the left side bearing 20.

As shown in FIG. 2, the right side valve shaft portion 22 extends outward through the corresponding bearing fitting portion 18 and has an outer axial end that is coupled to an interlock member 28. In the case of an electronically controlled throttle valve device, the interlock member 28 may be driven by an actuator as a drive source, which may be an electric motor. In the case of a mechanically controlled throttle valve device, the interlock member 28 may be rotated via the accelerator linkage.

As the throttle valve member 14 is rotated by the rotation of the interlock member 28, the bore 17 may be opened or closed by the valve body member 24, so that the flow of the intake air through the bore 17 can be controlled. In this embodiment, the bore 17 may be opened as the throttle valve member 14 rotates from a fully closed position (indicated by solid lines in FIG. 1) in an opening direction indicated by an arrow 0 in FIG. 1. On the other hand, the bore 17 may be closed as the throttle valve member 14 rotates from a fully opened position (indicated by two-dot chain lines in FIG. 1) in a closing direction indicated by an arrow S in FIG. 1.

Sealing structures for sealing between the bearing fitting portions 18 of the throttle body 12 and the throttle valve member 14 will now be described. In FIG. 2, the right side sealing structure and the left side sealing structure are symmetrical with each other. Therefore, only the left side sealing structure will be explained and the explanation of the left side sealing structure will be omitted.

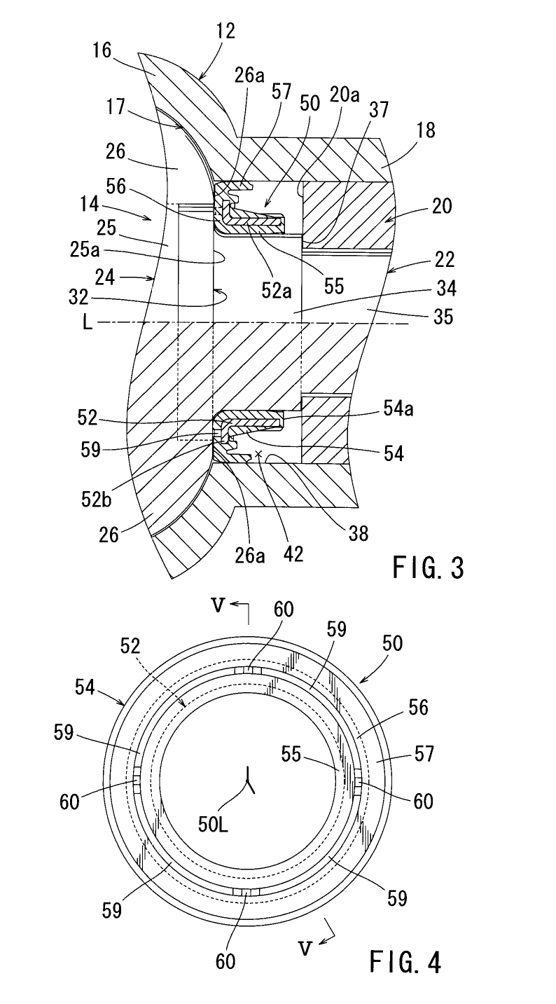

Referring to FIG. 3, the valve body portion 24 has an end face 32 that defines a flat plane perpendicular to the axis L. The end face 32 includes an annular end face 25a on the right side of the support shaft portion 25 and end faces 26a on the right side of the valve plate portions 26. In FIG. 1, the right side valve shaft portion 22 is positioned within the annular end face 25a of the support shaft portion 25 so as to be coaxial therewith. The end face 32 of the valve body portion 24 and an inner end face 20a of the corresponding bearing 20 oppose to each other in an axial direction (right and left directions as viewed in FIG. 3) and a positioned in parallel to each other. In addition, the end face 32 and the inner end face 20a are spaced from each other by a predetermined clearance.

Each of the valve shaft portions 22 has at least two shaft parts 34 and 35 with different diameters, so that the outer diameter (shaft diameter) of the valve shaft portion 22 decreases in stepwise fashion in a direction from the side of the valve body portion 24 (base end side) toward the outer end (distal end) of the valve shaft portion 22. In this embodiment, the right side valve shaft portion 22 has three shaft parts 34, 35 and 36, while the left side valve shaft portion 22 has two shaft parts 34 and 35. The shaft parts 34 and 35 (and 36) are positioned along the same axis and two adjacent shaft parts are connected with each other via a stepped face that is perpendicular to the axis of the shaft parts. The interlock member 28 is coupled to the shaft part 36 formed on the axial end of the right side valve shaft portion 22. The shaft part 35 at the second step from the smaller diameter side (hereinafter also called “second shaft part”) of the right side valve shaft portion 22 has an axial length that is so long enough to extend outward from the corresponding bearing fitting portion 18. The shaft part 35 at the second step from the smaller diameter side of the left side valve shaft portion 22 has an axial length that is so short enough not to extend outward from the corresponding bearing fitting portion 18. The shaft part 34 at the first step from the smaller diameter side or at the base end (hereinafter also called “first shaft part”) of each of the valve shaft portions 22 has an outer diameter that is smaller than the outer diameter of the support shaft portion 25 of the throttle valve member 14 but is larger than the outer diameter of the second shaft part 35.

As shown in FIG. 2, the inner circumferential face of each bearing fitting portion 18 of the throttle body 12 has at least two face parts with different diameters, so that the inner diameter of the bearing fitting portion 18 increases in stepwise fashion in a direction from the side of the bore 17 (inner side) toward the outer end (distal end) of the bearing fitting portion 18. The at least two face parts includes a face part 38 on the smaller diameter side or the side of the bore 17 (hereinafter also called “first face part”). In this embodiment, as shown in FIG. 2, the inner circumferential face of the right side bearing fitting portion 18 has three face parts having the same axis. On the other hand, the inner circumferential face of the left side bearing fitting portion 18 has four face parts having the same axis. The first face part 38 has an axial length corresponding to the sum of the axial length of the first shaft part 34 and the axial length of the base end of the second shaft part 35. In this way, the first face part 38 and the outer circumferential face of the corresponding valve shaft portion 22 (more specifically, the first shaft part 34) oppose to each other in the diametrical direction.

As shown in FIG. 32, an annular space 42 is defined between the inner circumferential face 38 of the right side bearing fitting portion 18 and the outer circumferential face of the valve shaft portion 22 with respect to the radial direction and between the inner end face 20a of the right side bearing 20 and the end face 32 of the throttle valve member 14 with respect to the radial direction. A seal member 50 is disposed within the annular space 42. For the purpose of explanation, the side of the seal member 50 opposing to the end face 32 of the throttle valve member 14 will be referred to as the front side, and the side of the seal member 50 opposing to the inner end face 20a of the right side bearing 20 will be referred to as the rear side.

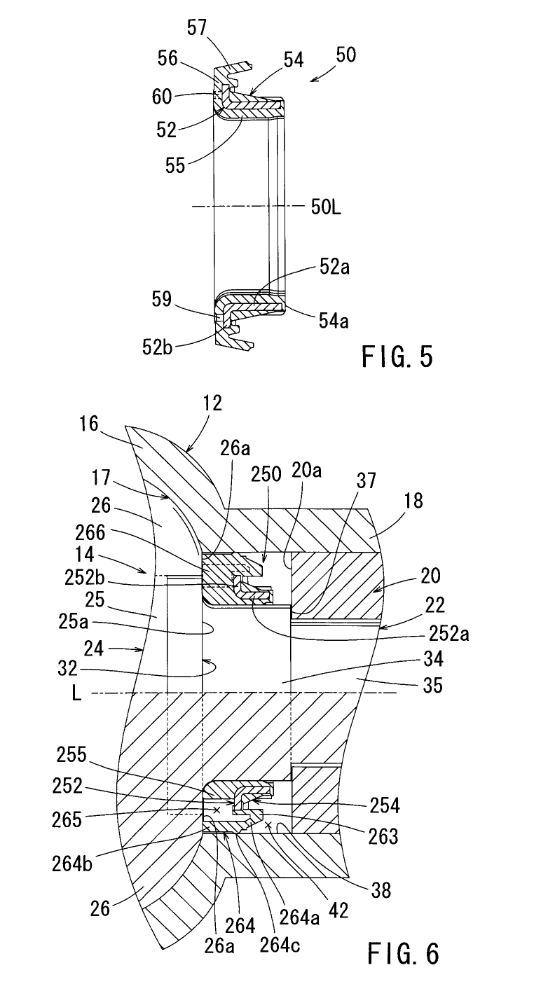

As shown in FIG. 5, the seal member 50 includes an annular member 52 made of metal and a resilient member 54 made of rubber or the like, which is molded integrally with the annular member 52, so that the annular member 52 is substantially embedded within the resilient member 54. For example, the annular member 52 may be formed by a press-molding process of an iron plate and includes a main tubular portion 52a having a cylindrical tubular configuration and a flange portion 52b that extends radially outward from the front end of the main tubular portion 52a.

As the material of the resilient member 54, high-density nitrile-butadiene rubber (H-NBR) and fluorinated silicon rubber may be used. The resilient member 54 includes a cylindrical inner seal portion 55 covering the inner side of the main tubular portion 52a of the annular member 52, an annular front side seal portion 56 for covering the front side of the flange portion 52b of the annular member 52, and a skirt-like negative-pressure receiving lip 57 extending rearwardly from the outer circumferential part of the front side seal portion 56 and having a diameter enlarging rearwardly (see FIGS. 4 and 5). A suitable number (four in this embodiment) of elongated slots 59 are formed in the front side seal portion 56 and extend in the circumferential direction about an axis 50L. The elongated slots 59 are spaced equally from each other by a predetermined distance (such as an angle of 90°). A rib 60 is formed between each two adjacent elongated slots 59 and connects between the inner circumferential side seal part and the outer circumferential side seal part of the front side seal portion 56 (see FIG. 4).

As shown in FIG. 3, the seal member 50 is fixed in position within the annular space 42 by fitting the inner seal portion 55 on the first shaft part 34 of the valve shaft portion 22 with a predetermined fitting tolerance. In this connection, the main tubular portion 52a of the annular member 52 restricts the resilient deformation in the radially outer direction of the inner seal portion 55, so that the inner seal portion 55 is fixed in position relative to the first shaft part 34 of the valve shaft part 34 with the predetermined fitting tolerance. The front side seal portion 56 resiliently contacts in face-to-face contact relation with the end face 32 of the throttle valve member 14, so that the end face 32 closes the open end face of the elongated slots 59 of the front side seal portion 56.

The negative-pressure receiving lip 57 resiliently contacts the entire circumference of the face part 38 of the inner circumferential face of the bearing fitting portion 18. In this way, the inner seal portion 55 serves to seal against the outer circumferential face of the valve shaft portion 22. The front side seal portion 56 serves to seal the end face 32 of the throttle valve member 14. The negative-pressure receiving lip 57 serves to seal against the face part 38 of the inner circumferential face of the bearing fitting portion 18. When the negative pressure has been created within the bore 17, the negative-pressure receiving lip 57 can resiliently deform to increase the contact pressure against the face part 38 of the inner circumferential face of the bearing fitting portion 18. In this way, the negative-pressure receiving lip 57 can resiliently deform in response to the negative pressure within the bore 17. In this embodiment, the inner end face 20a of the bearing 20 and a rear end face 54a of the seal member 50 are spaced apart from each other. However, the inner end face 20a and the rear end face 54a may contact with each other.

An example of a process for assembling the seal members 50 and the bearings 20 of the throttle valve device 10 will now be described. First, the throttle valve member 14 is resin-molded by an injection molding process, and the throttle body 12 is then resin-molded by an injection molding process with the throttle valve member 14 inserted into a mold for molding the throttle body 12. Alternatively, the throttle body 12 is first resin-molded by an injection molding process, and the throttle valve member 14 is then resin-molded by an injection molding process with the throttle body 12 inserted into a mold for molding the throttle valve member 14. Subsequently, the seal members 50 are fitted into the respective annular spaces 42 formed between the throttle body 12 and the throttle valve member 14. Thereafter, the bearings 20 are fitted into the respective annular spaces 42 so as to close the open end faces of the annular spaces 42. With this process, the throttle valve device 10 is completed (see FIGS. 1 and 2). During this process, the fitting positions of the bearings 20 can be set due to contact of the inner end faces 20a with the corresponding end faces 32 of the throttle valve member 14.

As shown in FIG. 3, each bearing 20 is press-fitted into the corresponding bearing fitting portion 18 (more specifically, the face part 38 of the inner circumferential face), while it is loosely fitted onto the corresponding valve shaft portion 22 (more specifically, the second shaft portion 35). Therefore, the valve shaft portions 22 of the throttle valve member 14 are rotatably supported within the corresponding bearing fitting portions 18 of the throttle body 12 via the bearings 20, while the seal members 50 seal between the valve shaft portions 22 and the corresponding bearing fitting portions 18. In an alternative arrangement, each bearing 20 is press-fitted onto the corresponding valve shaft portion 22 (more specifically, the second shaft portion 35), while it is loosely fitted into the corresponding bearing fitting portion 18 (more specifically, the face part 38). In another alternative arrangement, each bearing 20 is press-fitted onto the corresponding valve shaft portion 22 (more specifically, the second shaft portion 35) and is press-fitted also into the corresponding bearing fitting portion 18 (more specifically, the face part 38).

With throttle valve device 10 described above, the valve body portions 24 can open or close the bore 17 of the throttle body 12 as the throttle valve member 14 rotates, so that the amount of intake air flowing through the bore 17, i.e., the flow rate of the intake air, can be controlled. As the throttle valve member 14 rotates, the seal members 50 rotate with the throttle valve member 14, so that the negative-pressure receiving lips 57 slidably move in contact relation with the corresponding face parts 18 of the inner circumferential faces of the bearing fitting portions 18.

The seal members 50 are disposed within the respective annular spaces 42 that are defined between the bearing fitting portions 18 of the throttle body 12 and the corresponding valve shaft portions 22 of the throttle valve member 14 with respect to the diametrical direction and between the end faces 20a of the bearings 20 and the corresponding end face 32 of the throttle valve member 14 (see FIG. 3). The inner seal portions 55 of the seal members 50 seal against the corresponding outer circumferential faces of the first shaft parts 34 of the valve shaft portions 22. The front seal portions 56 of the seal members 50 seal against the corresponding end face 32 of the throttle valve member 14. Further, the negative-pressure receiving lips 57 seal against the corresponding face parts 38 of the inner circumferential faces of the bearing fitting portions 18.

Therefore, each sealing member 50 that is a single component can seal between the bearing fitting portion 18 and the bearing shaft portion 22 with respect to the radial direction, and at the same time, it can seal between the bearing 20 and the throttle valve member 14 with respect to the axial direction. Hence, without accompanying increase in the number of parts or the assembling steps, it is possible to prevent or reduce the potential leakage of the intake air from the bore 17 to the outside, while it is possible to prevent the potential leakage of the intake air from the upstream side to the downstream side of the throttle valve member 14 when the throttle valve member 14 is in a fully closed position.

Because the seal members 50 are fixed in position relative to the corresponding valve shaft portions 22 of the throttle valve member 14, it is possible to accurately position the seal members 50.

The inner seal portions 55 are resiliently fitted on the corresponding valve shaft portions 22, to which the sealing members 50 are fixed in position. The annular members 52 are provided for restricting the resilient deformation in the radial direction of the corresponding inner seal portions 55. Therefore, it is possible to improve the secure positioning of the seal members 50 on the corresponding valve shaft portions 22 or the corresponding bearing fitting portions 18 of the throttle valve member 14.

The seal members 50 have respective negative-pressure receiving lips 57 that can resiliently deform to increase the contact pressure against the corresponding face parts 38 of the inner circumferential faces of the bearing fitting portions 18 due to the negative pressure created within the bore 17. Therefore, it is possible to improve the sealing ability of the seal members 50 against the negative pressure within the bore 17. In addition, the negative-pressure receiving lips 57 can deform to follow the movement in the axial direction and/or the radial direction of the throttle valve member 14 relative to the corresponding bearing fitting portions 18 of the throttle body 12. Therefore, it is possible to prevent or minimize the potential degradation in the sealing ability, which may be caused due to the movement of the valve member 14.

The second to eleventh embodiments will now be described. These embodiments are modifications of the first embodiment. Therefore, like members are given the same reference numerals as the first embodiment and the description of these members will not be repeated.

### Second Embodiment

A second embodiment will now be described with reference to FIGS. 6 to 8. This embodiment is different from the first embodiment in the configurations of the annular members 52 and the resilient members 54 of the seal members 50 (see FIGS. 4 and 5). Also in this embodiment, the right side sealing structure and the left side sealing structure for sealing between the bearing fitting portions 18 of the throttle body 12 and the throttle valve member 14 are symmetrical with each other. Therefore, only the left side sealing structure will be explained and the explanation of the left side sealing structure will be omitted. As shown in FIG. 8, a seal member 250 of this embodiment has an annular member 252 and a resilient member 254. The annular member 252 has a main tubular portion 252a and a flange portion 252b. The main tubular portion 252a has a short axial length, so that the annular member 252 is embedded within a rear half portion of the resilient member 254.

As shown in FIG. 8, the resilient member 254 has an inner seal portion 255, a support tube portion 262, a support plate portion 263, and a skirt-like positive-pressure receiving lip 264. The inner seal portion 255 has a cylindrical tubular configuration and serves to cover the inner circumferential side of the main tubular portion 252a of the annular member 252. The inner seal portion 255 extends forwardly from the main tubular portion 252a. The support tube portion 262 has a cylindrical tubular configuration and extends rearward from the outer circumference of flange portion 252b of the annular member 252. The support plate portion 263 extends radially outward from the rear end of the support tube portion 262. The positive-pressure receiving lip 264 extends forwadly from the outer circumference of the support plate portion 263.

The positive pressure-receiving lip 264 has a main lip part 264a, a cylindrical tubular part 264b and a projection 264c. The main lip part 264a extends fowardly from the outer circumference of the support plate portion 263 and has a diameter increasing in the forward direction. The cylindrical tubular part 264b extends forwardly from the main lip part 264a. The projection 264c projects radially outward from the rear end of the cylindrical tubular part 264b and extends along the circumference of the cylindrical tubular part 264b. The projection 264b has a semi-circular cross sectional configuration. A space 265 is defined between the inner seal portion 255 and the positive-pressure receiving lip 264. The space 265 has an open front end and a rear end that is closed by the support tube portion 262 and the support plate portion 263. A plurality of ribs 266 are provided for connecting between the inner seal portion 255 and the positive-pressure receiving lip 264 in the radial direction and extends across the space 265. The ribs 266 are spaced equally from each other in the circumferential direction. In this embodiment, two ribs 266 are provided and are spaced from each other by an angle of 180°.

As shown in FIG. 6, within the annular space 42, the seal member 250 is fixed in position relative to the first shaft part 34 of the valve shaft portion 22 by fitting the inner seal portion 255 on the first shaft part 34 with a predetermined fitting tolerance. In this connection, the main tubular portion 252a of the annular member 252 restricts the resilient deformation in the radially outer direction of the rear half of the inner seal portion 255, so that the inner seal portion 255 is fixedly fitted on the first shaft part 34 of the valve shaft portion 22 with the predetermined fitting tolerance. The front end face of the inner seal portion 255 and the front end face of the tubular part 264b of the positive-pressure receiving lip 264 resiliently contact in face-to-face contact relation with the end face 32 of the throttle valve member 14.

The projection 264c of the positive-pressure receiving lip 264 resiliently contacts the entire circumference of the face part 38 of the inner circumferential face of the bearing fitting portion 18 of the throttle body 12. As the seal member 250 rotates with the throttle valve member 14, the projection 264 slidably moves in contact relation with the face part 38. The inner seal portion 255 serves to seal against the outer circumferential face of the valve shaft portion 22. In addition, the front end of the inner seal portion 255 and the front end of the tubular part 264b of the positive-pressure receiving lip 264 serve to seal against the end face 32 of the throttle valve member 14. Further, the positive-pressure receiving lip 264 serves to seal against the face part 38 of the inner circumferential face of the bearing fitting portion 38 as described above and can resiliently deform to increase the contact pressure against face part 38 due to the positive pressure that may be created within the bore 17.

Also with this embodiment, substantially the same advantages as the first embodiment can be achieved. In addition, because the positive-pressure receiving lip 264 is provided, it is possible to improve the sealing ability against the positive pressure that may be created within the bore 17. Further, the positive-pressure receiving lip 264 can deform to follow the movement in the axial direction and/or the radial direction of the throttle valve member 14 relative to the corresponding bearing fitting portion 18 of the throttle body 12. Therefore, it is possible to prevent or minimize the potential degradation in the sealing ability, which may be caused due to the movement of the valve member 14.

Further, according to this embodiment, the outer circumferential side of the space 265 of the seal member 50 opposes the corresponding end faces 26a of the valve plate portions 26 of the throttle valve member 14. Therefore, the ribs 266 may contact the end faces 26a in order to prevent or minimize the potential leakage of the intake air from the upstream side of the throttle valve member 14 to the downstream side via the space 265 when the throttle valve member 14 is in a fully closed position.

### Third Embodiment

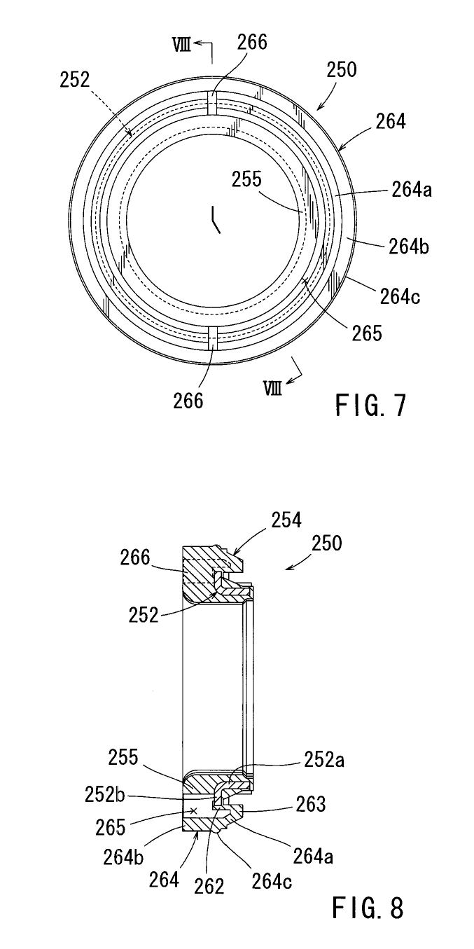

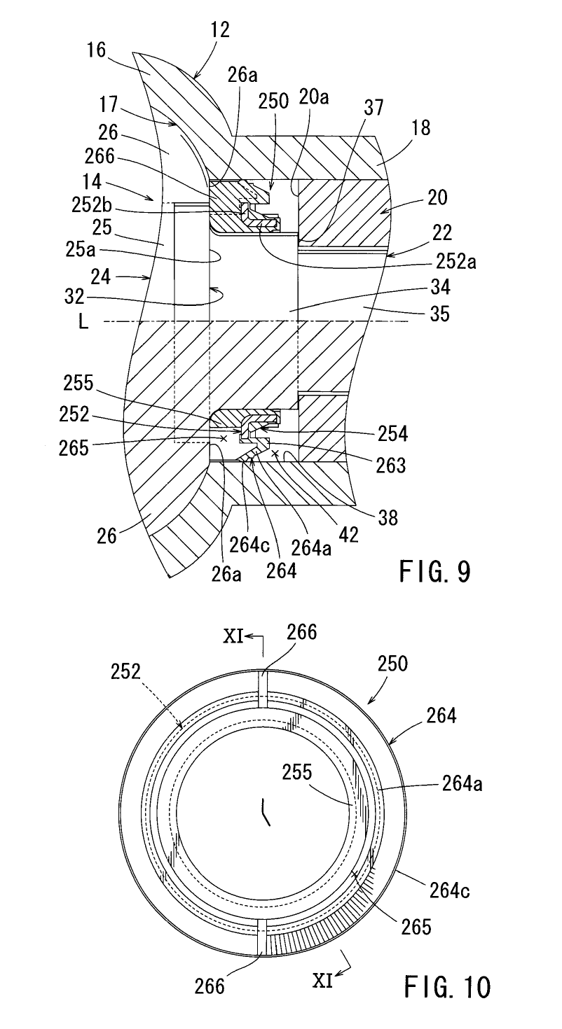

A third embodiment will now be described with reference to FIGS. 9 to 11. This embodiment is a modification of the second embodiment and is different form the second embodiment in that a part of the tubular part 264b of the positive-pressure receiving lip 264 the seal member 250 (see FIGS. 7 and 8), which part is positioned on the side forwardly of the projection 264c, is removed or cut away. In this connection, the ribs 266 extend radially outward to have radially outer ends that are axially aligned with the radially outer circumferential end of the positive-pressure receiving lip 264.

Also with this embodiment, it is possible to achieve substantially the same advantages as the second embodiment. In addition, because the contact area of the positive-pressure receiving lip 264 with the face part 38 of the inner circumferential face of the bearing fitting portion 18 of the throttle body 12 can be reduced, it is possible to reduce the resistance against the sliding movement of the positive-pressure receiving lip 264 relative to the face part 38.

### Fourth Embodiment

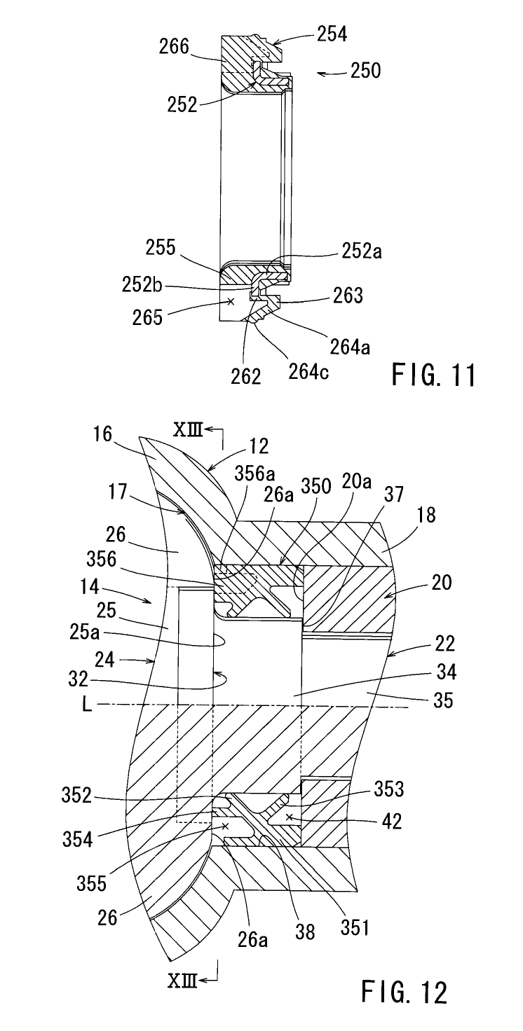

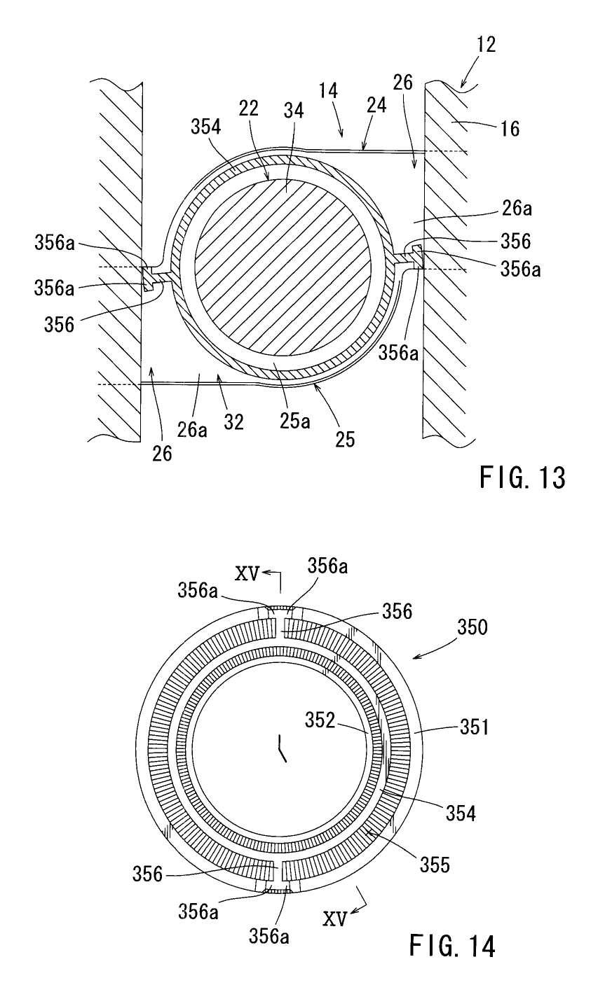

A fourth embodiment will now be described with reference to FIGS. 12 to 16. This embodiment is different from the first embodiment in the construction of the seal member 50 (see FIGS. 4 and 5). Thus, as shown in FIGS. 14 to 16, a seal member 350 of this embodiment consists of only a resilient member made of rubber or the like.

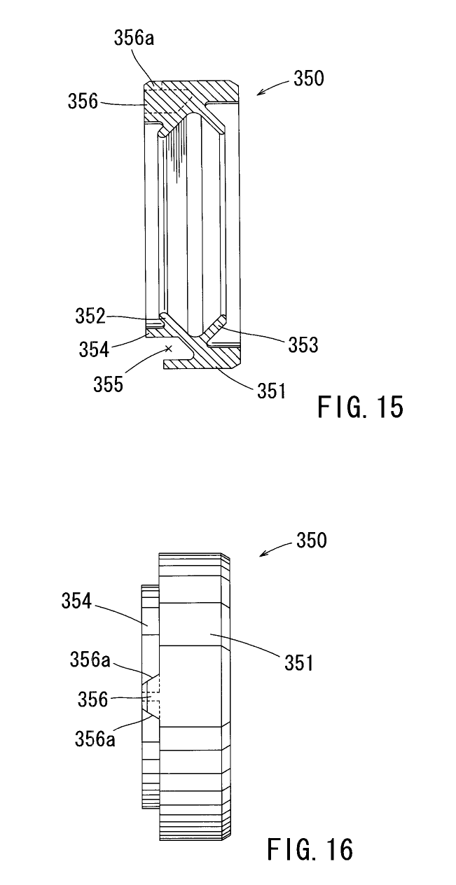

As shown in FIG. 15, the seal member 350 has an outer seal portion 351, a positive-pressure receiving lip 352, a negative-pressure receiving lip 353 and a front side seal portion 354. The outer seal portion 351 has a cylindrical tubular configuration. The positive-pressure receiving lip 352 extends forwardly from a central portion with respect to the axial direction of the inner circumferential face of the outer seal portion 351 and has a diameter decreasing in the forward direction in a manner like a truncated cone. The negative-pressure receiving lip 353 extends rearwardly from the base portion of the positive-pressure receiving lip 352 and has a diameter decreasing in the rearward direction in a manner like a truncated cone. The front side seal portion 354 has a cylindrical tubular configuration and extends forwardly from the central portion of the positive-pressure receiving lip 352. A space 355 is defined between the outer seal portion 351 and the front side seal portion 354. The space 355 has an open front end. The positive-pressure receiving lip 352 closes the rear side of the space 355. A plurality of ribs 356 are provided for connecting between the outer seal portion 351 and the front side seal portion 354 in the radial direction and extends across the space 355. The ribs 356 are spaced equally from each other in the circumferential direction. In this embodiment, two ribs 356 are provided and are spaced from each other by an angle of 180°. Each rib 356 has an outer end with a pair of circumferential extensions 356a extending in opposite directions to each other. In a side view of the seal member 350 shown in FIG. 16, the circumferential extensions 356a jointly form a substantially trapezoidal configuration that is tapered in a direction away from the front edge of the outer seal portion 351.

As shown in FIG. 12, the seal member 350 is fixed in position within the annular space 42 by press-fitting the outer seal portion 351 into the face part 38 of the inner circumferential face of the bearing fitting portion 18 with a predetermined fitting tolerance. The front end face of the front seal portion 354 resiliently contacts in face-to-face contact relation with the end face 32 of the throttle valve member 14. The inner circumferential edge of the positive-pressure receiving lip 352 and the inner circumferential edge of the negative-pressure receiving lip 353 resiliently contact the outer circumferential face of the first shaft part 34 of the valve shaft portion 22 over the entire circumference of the outer circumferential face. The inner end face 20a of the bearing 20 is in face-to-face contact relation with the rear end face of the outer seal portion 351. The outer seal portion 351 serves to seal against the face part 38 of the inner circumferential face of the bearing fitting portion 18. The front side seal portion 354 serves to seal against the end face 32 of the throttle valve member 14. The positive-pressure receiving lip 352 and the negative-pressure receiving lip 353 serve to seal against the outer circumferential face of the valve shaft portion 22. The positive-pressure receiving lip 352 can resiliently deform to increase the contact pressure against the outer circumferential face of the valve shaft portion 22 due to the positive pressure that may be created within the bore 17. The negative-pressure receiving lip 353 can resiliently deform to increase the contact pressure against the outer circumferential face of the valve shaft portion 22 due to the negative pressure that may be created within the bore 17.

Also with this embodiment, it is possible to achieve substantially the same advantages as the first embodiment. In addition, because the seal member 350 is fixedly fitted to the bearing fitting portion 18 of the throttle body 12, it is possible to accurately position the seal member 350. Therefore, as the throttle valve member 14 rotates, the outer circumferential face of the valve shaft portion 22 moves in slide contact relation with the positive-pressure receiving lip 352 and the negative-pressure receiving lip 353, and the end face 32 moves in slide contact relation with the front side seal portion 354.

In addition, when a positive pressure has been created within the bore 17, the positive-pressure receiving lip 352 resiliently deforms to increase the contact pressure against the outer circumferential face of the valve shaft portion 22. Even in the event that a negative pressure has been created within the bore 17 and has caused resilient deformation of the positive-pressure receiving lip 352 (to decrease the contact pressure against the outer circumferential face of the valve shaft portion 22), the negative pressure may cause resilient deformation of the negative-pressure receiving lip 353 to increase the contact pressure against the outer circumferential face of the valve shaft portion 22. Therefore, the sealing ability may be improved against both of the positive pressure and the negative pressure that may be created within the bore 17. Further, the positive-pressure receiving lip 352 and the negative-pressure receiving lip 353 can deform to follow the movement in the axial direction and/or the radial direction of the throttle valve member 14 relative to the corresponding bearing fitting portions 18 of the throttle body 12. Therefore, it is possible to prevent or minimize the potential degradation in the sealing ability, which may be caused due to the movement of the valve member 14.

Further, the seal member 350 may be fixedly fitted into the corresponding bearing fitting portion 18 of the throttle body 12 in such a position that the ribs 356 oppose to the corresponding end face 32 of the throttle valve member 14 including the end faces 26a of the valve plate portions 26 when the throttle valve member 14 is in the fully closed position. With this arrangement, it is possible to prevent or minimize the potential leakage of the intake air from the upstream side to the downstream side of the throttle valve member 14 via the space 355. Furthermore, because the extensions 356a are provided in addition to the ribs 356, it is possible to further effectively prevent or minimize the potential leakage of the intake air from the upstream side to the downstream side of the throttle valve member 14 via the space 355.

### Fifth Embodiment

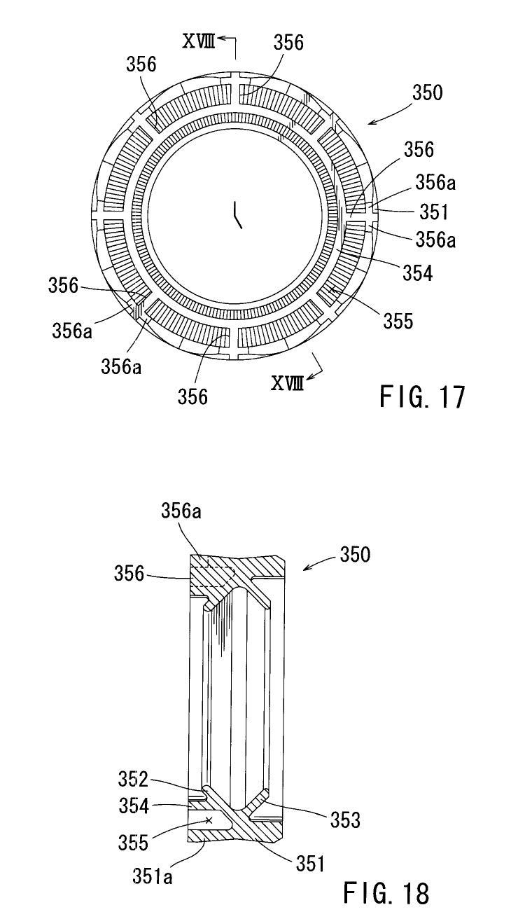

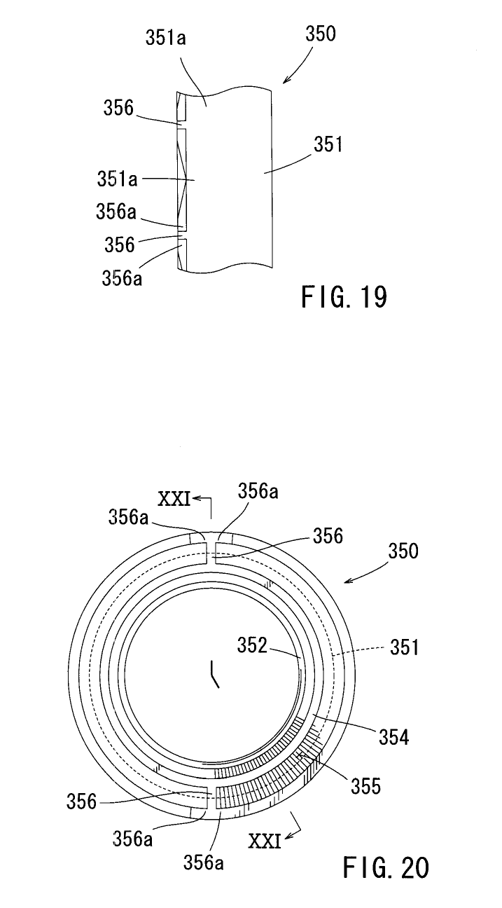

A fifth embodiment will now be described with reference to FIGS. 17 to 19. This embodiment is a modification of the fourth embodiment and is different from the fourth embodiment in that eight ribs 356 are provided and are spaced approximately equal from each other by an angle of 45°. In addition, the outer seal portion 351 has a front extension 351a extending forwardly (leftwardly as viewed in FIG. 18) from the outer seal portion 351 and joined to the extensions 356a of the ribs 356 (see FIGS. 18 and 19).

Also with this embodiment, it is possible to achieve substantially the same advantages as the fourth embodiment. In addition, because of the increase in number of the ribs 356 and their extensions 356a, it is possible to prevent the outer seal portion 351, the positive-pressure receiving lip 352 and the front side seal portion 354 from being excessively deformed.

### Sixth Embodiment

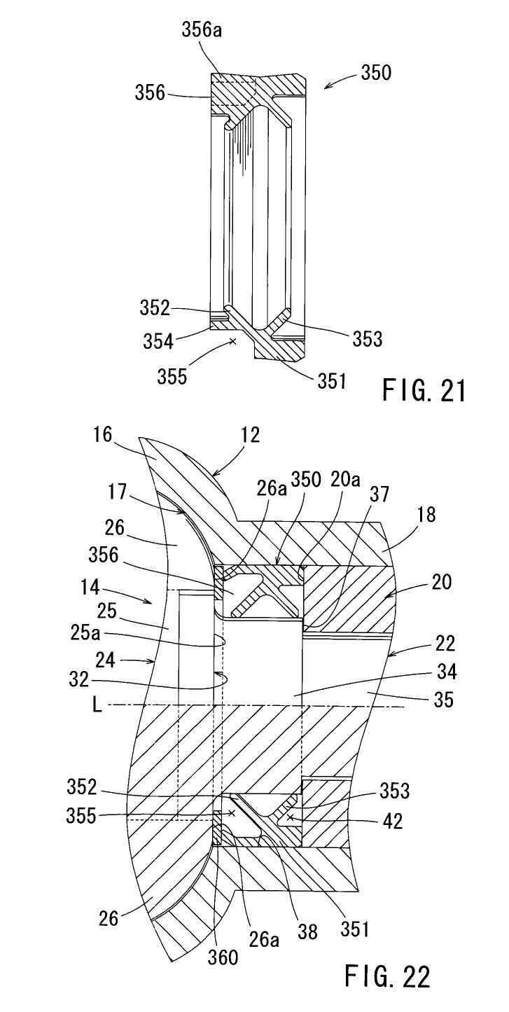

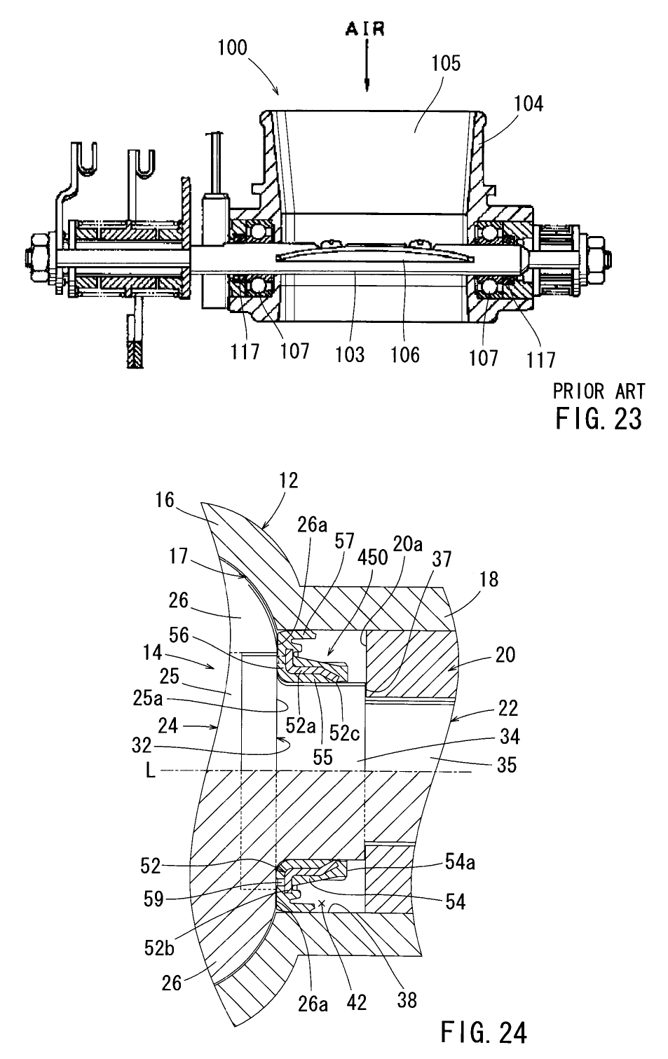

A sixth embodiment will now be described with reference to FIGS. 20 and 21. Also, this embodiment is a modification of the fourth embodiment and is different from the fourth embodiment in that the front half of the outer seal portion 351, in that a part of the outer seal portion 351 on the front side of the positive-pressure receiving lip 352 is removed or cut away. The ribs 356 extended in the axial direction so as to be joined to the outer seal portion 351.

Also with this embodiment, substantially the same advantages as the fourth embodiment can be achieved. In addition, because the axial length of the outer seal portion 351 can be shortened, the assembling operation of the seal member 350 with the corresponding bearing fitting portion 18 of the throttle body 12 can be facilitated.

### Seventh Embodiment

A seventh embodiment will now be described with reference to FIG. 22. Also, this embodiment is a modification of the fourth embodiment (see FIG. 12) and is different from the fourth embodiment in that an annular plate-like slide member 360 is interleaved between the end face 32 of the throttle valve member 14 and the outer seal portion 351 of the seal member 350. The slide member 360 slidably contacts the end face 32 of the throttle valve member 14 and is integrated with the front end face of the outer seal portion 351 by adhesion or heat-bonding, The slide member 360 may be made of material having a low frictional resistance, such as high-density nitrile-butadiene rubber (H-NBR) and fluorinated silicon rubber. Alternatively, the slide member 360 may be made of a metal plate with a lubrication film at least on its sliding side face. The lubrication film may be a coating made of polytetrafluoroethylene resin, molybdenum disulfide, or graphite. Further, in this embodiment, the front side seal portion 354 (see FIG. 12) of the fourth embodiment is omitted.

Also with this embodiment, it is possible to achieve substantially the same advantages as the fourth embodiment. In addition, the slide member 360 is provided between the end face 32 of the throttle valve member 14 and the outer seal portion 351 of the seal member 350 and slidably contacts the end face 32 of the throttle valve member 14. Therefore, it is possible to prevent or minimize the potential wear or damage of the outer seal portion 351 of the seal member 350, which may be caused due to sliding contact with the end face 32 of the throttle valve member 14

Further, because the slide member 360 is integrated with the seal member 350, the slide member 360 can be reliably positioned relative to the seal member 350.

### Eighth Embodiment

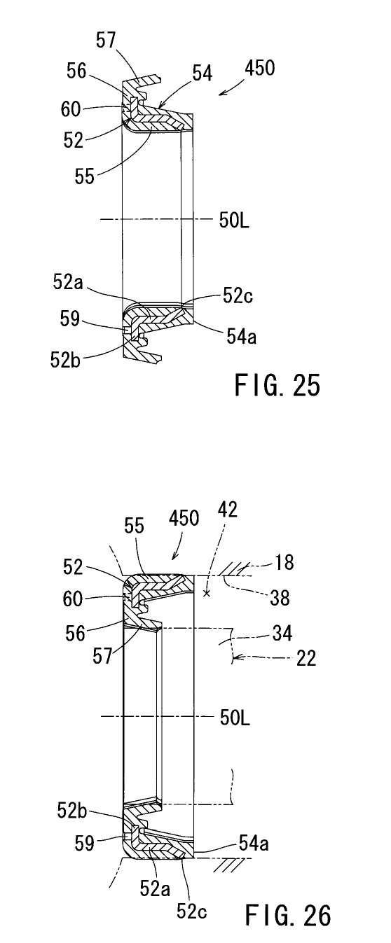

An eighth embodiment will now be described with reference to FIGS. 24 and 25. This embodiment is a modification of the first embodiment and is different from the first embodiment in the configuration of the annular member 52. As shown in FIG. 25, with a seal member 450 of this embodiment, an end portion of the main tubular portion 52a of the annular member 52 on the side of the bearing 20 (right side as viewed in FIG. 24) is tapered to decrease its diameter towards the bearing 20. The tip end of the end portion of the main tubular portion 52a on the side of the bearing 20 is exposed on the inner circumferential face of the resilient member 54 and serves as a contract part 52c as will be hereinafter explained.

As shown in FIG. 24, within the annular space 42, the seal member 450 is fixed in position relative to the first shaft part 34 of the valve shaft portion 22 by fitting the inner seal portion 55 of the resilient member 54 onto the first shaft part 34 with a predetermined tolerance. With this fitting operation, the contact part 52c of the annular member 52 resiliently contacts the outer circumferential face of the first shaft part 34.

Also with this embodiment, substantially the same advantages as the first embodiment can be achieved. In addition, because the resilient member 52 has the contact part 52c that resiliently contacts the outer circumferential face of the first shaft part 34, it is possible to position the seal member 450 relative to the first shaft part 34 with respect to the axial direction and also with respect to a rotational direction about the axis. By enabling the positioning of the seal member 450 with respect to the axial direction, it is possible to effectively prevent the potential spring-back phenomenon of the seal member 450, which may be caused when the seal member 450 is mounted. The spring-back phenomenon is a phenomenon causing the seal member 450 to return to the direction opposite to the fitting direction (right direction as viewed in FIG. 24) due to the resiliency of the inner seal portion 55 of the resilient member 54 when the seal member 450 is fitted onto the first shaft part 34.

In this embodiment, the valve shaft portion 22 is made of resin and the annular member 52 is made of metal. Therefore, the contact part 52c may bite into the outer circumferential face of the first shaft part 34 of the valve shaft portion 22 when the spring-back phenomenon has been caused. Therefore, it is possible to effectively prevent or minimize the potential movement of the seal member 450 in the axial direction and in the rotational direction about the axis.

The inner circumferential side and the outer circumferential side of the seal member 450 may be reversed as shown in FIG. 26. With this arrangement, within the annular space 42, the seal member 450 may be fixed in position by fitting the seal portion 55 (positioned on the outer side in the arrangement of FIG. 26) of the resilient member 54 into the face part 38 of the inner circumferential face of the bearing fitting portion 18 with a predetermined tolerance. In this connection, the contact part 52c of the annular member 52 resiliently contacts the face part 38. The negative-pressure receiving lip 57 resiliently contacts the outer circumferential face of the first shaft part 34 of the valve shaft portion 22 over the entire circumference.

### Ninth Embodiment

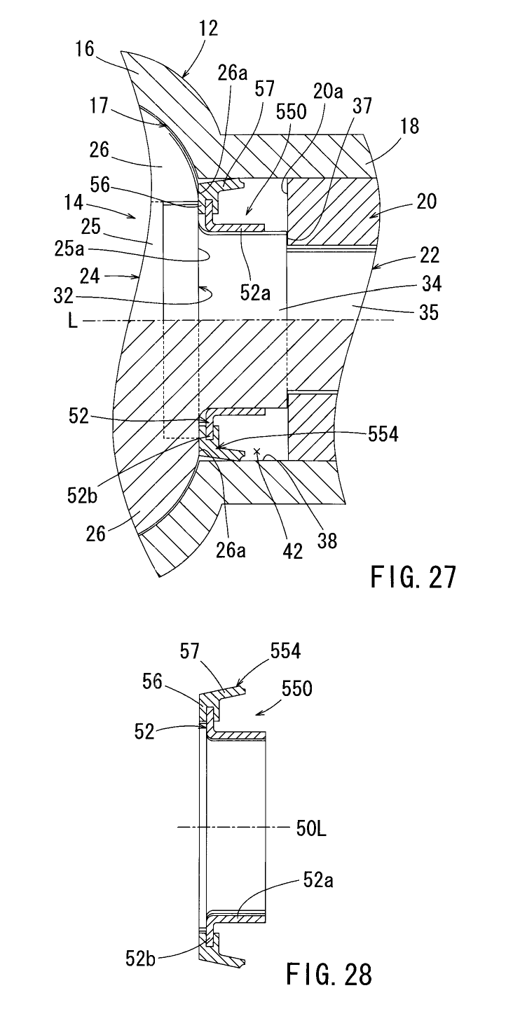

A ninth embodiment will now be described with reference to FIGS. 27 and 28. This embodiment is a modification of the first embodiment is different from the first embodiment in the configurations of the annular member 52 and the resilient member 54 of the seal member 50 (see FIGS. 4 and 5). As shown in FIG. 28, according to a seal member 550 of this embodiment, a resilient member 554 has a configuration corresponding to the resilient member 50 with the inner half portion omitted, so that the main tubular portion 52a of the annular member 52 is exposed on the inner circumferential side of the resilient member 554. The inner diameter of the main tubular portion 52a of the annular member 52 is set to enable press-fitting of the main tubular portion 52a onto the first shaft part 34 of the valve shaft portion 22. In this way, the annular member 52 serves as a press-fitting member.

As shown in FIG. 27, the seal member 550 is fixed in position within the annular space 42 by press-fitting the main cylindrical portion 52a of the annular member 52 onto the first shaft part 34 of the valve shaft portion 22. Press-fitting the main cylindrical portion 52a onto the first shaft part 34 may seal the main cylindrical portion 52a against the first shaft part 34. Also with this embodiment, substantially the same advantages as the first embodiment can be achieved.

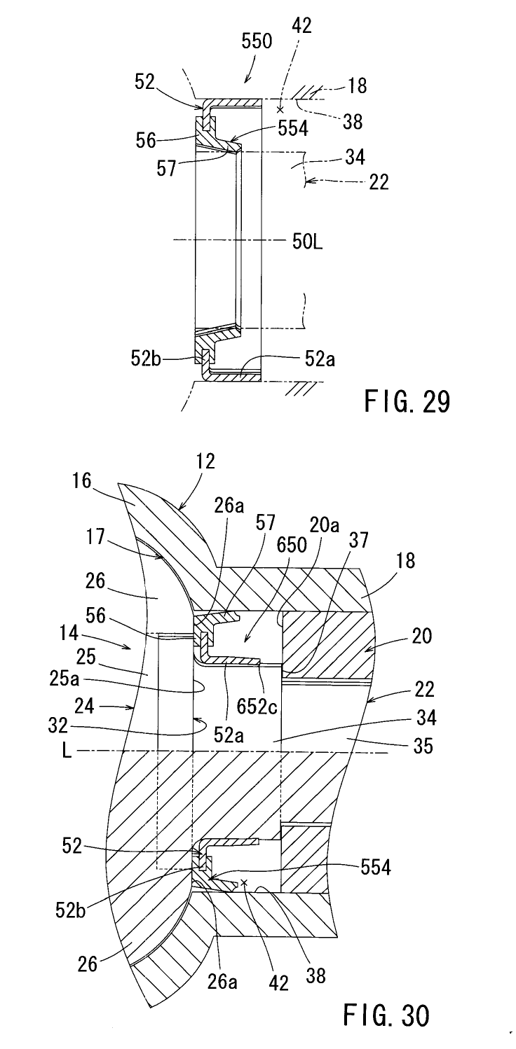

The inner circumferential side and the outer circumferential side of the seal member 550 may be reversed as shown in FIG. 29. With this arrangement, the seal member 550 may be fixed in position within the annular space 42 by press-fitting into the face part 38 of the inner circumferential face of the bearing fitting portion 18. The negative-pressure receiving lip 57 may resiliently contact the outer circumferential face of the first shaft part 34 of the valve shaft portion 22 over the entire circumference.

### Tenth Embodiment

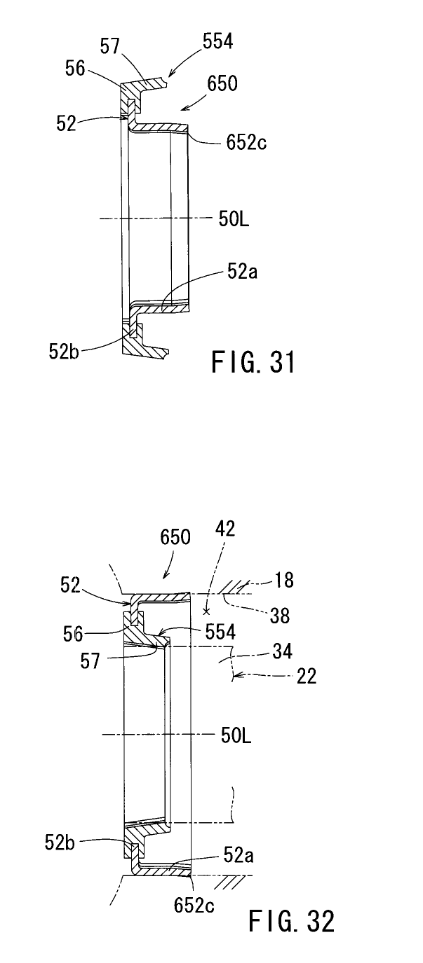

A tenth embodiment will now be described with reference to FIGS. 30 and 31. This embodiment is a further modification of the ninth embodiment and is different from the ninth embodiment in the configuration of the annular member 52 of the seal member 550 (see FIGS. 27 and 28). As shown in FIG. 31, with a seal member 650 of this embodiment, an end portion of the main tubular portion 52a of the annular member 52 on the side of the bearing 20 (right side as viewed in FIG. 30) is tapered to decrease its diameter towards the bearing 20, so that the tip end of the end portion of the main tubular portion 52a serves as a contract part 652c as will be hereinafter explained.

As shown in FIG. 30, within the annular space 42, the seal member 650 is fixed in position by fitting the main tubular portion 52a of the annular member 52 onto the first shaft part 34 of the bearing shaft portion 22. With this fitting operation, the contact part 652c of the annular member 52 resiliently contacts the outer circumferential face of the first shaft part 34.

Also with this embodiment, it is possible to achieve substantially the same advantages as the first embodiment. In addition, because the annular member 52 has the contact part 652c that resiliently contacts the outer circumferential face of the first shaft part 34, the seal member 650 can be positioned relative to the outer circumferential face of the first shaft part 34 with respect to the axial direction and the rotational direction about the axis. Positioning the seal member 650 in this way can effectively prevent the potential spring-back phenomenon of the seal member 650, which may be caused when the seal member 650 is mounted. The spring-back phenomenon may cause the seal member 650 to return to the direction opposite to the fitting direction (right direction as viewed in FIG. 30) due to the resiliency of the inner seal portion 55 (see FIG. 3) of the resilient member 54 when the seal member 650 is fitted onto the first shaft part 34.

Also, in this embodiment, the valve shaft portion 22 is made of resin and the annular member 52 is made of metal. Therefore, the contact part 652c may bite into the outer circumferential face of the first shaft part 34 of the valve shaft portion 22 when the spring-back phenomenon has been caused. Therefore, it is possible to effectively prevent or minimize the potential movement of the seal member 650 in the axial direction and in the rotational direction about the axis.

The inner circumferential side and the outer circumferential side of the seal member 650 may be reversed as shown in FIG. 32. With this arrangement, the seal member 650 may be fixed in position within the annular space 42 by press-fitting into the face part 38 of the inner circumferential face of the bearing fitting portion 18. The contact part 652 may resiliently contacts the face part 38 of the inner circumferential face of the bearing fitting portion 18. The negative-pressure receiving lip 57 may resiliently contact the outer circumferential face of the first shaft part 34 of the valve shaft portion 22 over the entire circumference.

### Eleventh Embodiment

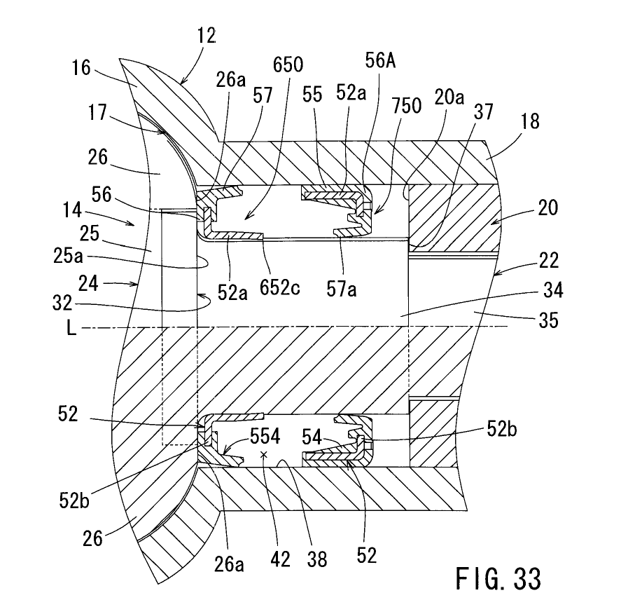

An eleventh embodiment will now be described with reference to FIG. 33. This embodiment is a further modification of the tenth embodiment and is different from the tenth embodiment in that according to a sealing structure of the eleventh embodiment, another seal member 750 is disposed on the side of the bearings 20 (right side as viewed in FIG. 31) of the seal member 650 within the annular space 42. The seal member 750 has a configuration corresponding to the seal member 50 of the first embodiment with its inner circumferential side and the outer circumferential side reversed and turned upside down. Therefore, the seal member 750 has the seal portion 55 for sealing against the face part 38 of the inner circumferential face of the bearing fitting portion 18. The seal member 750 also has the seal portion 57 for sealing against the first shaft part 34 of the bearing shaft portion 22. For the purpose of explanation, the seal member 650 and the seal member 750 will be hereinafter called a first seal member 650 and a second seal member 750, respectively.

The second seal member 750 is fixed in position within the annular space 42 by fitting the seal portion 55 (positioned radially outer side) of the resilient member 54 into the face part 38 of the inner circumferential face of the bearing fitting portion 18 with a predetermined fitting tolerance. Due to turning upside down, the negative-pressure receiving lip 57 is converted into a positive-pressure receiving lip 57a that resiliently contacts the outer circumferential face of the first shaft part 34 of the bearing fitting portion 22 over the entire circumference.

Also with this embodiment, substantially the same advantages as the first embodiment can be achieved. In addition, the second seal member 750 is provided within the annular space 42 on the side of the bearing 20 and has the seal portions 55 and 57 that seal against the face part 38 of the inner circumferential face of the bearing fitting portion and the outer circumferential face of the first shaft part 34, respectively. Therefore, the second seal member 750 provides a diametrical seal between the bearing fitting portion 18 and the first shaft part 34 of the valve shaft portion 22, so that the potential leakage of the intake air to the outside of the bore 17 and the potential leakage of the intake air from the upstream side to the downstream side of the throttle valve member 14 through the bore 17 when in the fully closed position can be further effectively prevented. With the seal member 750, a seal portion 56A corresponding to the front side seal portion 56 serves as a rear side seal portion. In FIG. 33, the seal portion 56A is positioned away from the inner end face 20a. However, the seal portion 56A may contact the inner end face 20a.

Because the resilient member 54 of the second seal member 750 has the positive-pressure receiving lip 57a, that can deform to increase the contact pressure against the outer circumferential face of the first shaft part 34 due the positive pressure that may be created within the bore 17, it is possible to improve the sealing ability against the positive pressure within the bore 17. The second seal member 750 may have a negative-pressure receiving lip in place of or in addition to the positive-pressure receiving lip 57a.

The present invention may not be limited to the above embodiments but may be modified in various ways. For example, although the valve shaft portions 22 and the valve body portion 24 are made of resin and are integrated with each other to form the throttle valve member 14 by a single molding process in the above embodiments, the valve body portion 24 may be molded by resin with the valve shaft portions 22, which are made of metal or resin, inserted into a mold. Alternatively, the valve shaft portions 22 may be molded by resin with the valve body portion 24, which is made of metal or resin, inserted into a mold. It is also possible to form the valve shaft portions 22 and the valve body portion 24 independently of each other and to mount the valve body portion 24 to the valve shaft portions 22 by screws or the like in order to form the throttle valve member 14.

Although each of the end faces 32 of the throttle valve body 14 opposing to the inner end faces 20a of the bearings 20 includes the annular end face 25a of the support shaft portion 25 and end faces 26a of the valve plate portions 26, each of the end faces 32 may include only the annular end face 25a of the support shaft portion 25. Alternatively, the end faces 32 may be stepped faces formed on the support shaft portion 25 or formed on the corresponding valve shaft portions 22.

Further, the configuration and the number of the resilient member of each seal member can be suitably determined. The number of the ribs of each resilient member can be increased or decreased as occasion demands. The ribs extending in the diametrical direction of each resilient member may be inclined in the circumferential direction. In addition, the ribs may be omitted and may be provided as occasion demands. The configuration or the position of the annular member (or the press-fitting member) of each seal member can be suitably determined. Further, although the slide member 360 is integrated with the seal member 350 in the seventh embodiment, the slide member 360 may be a separate member from the seal member 350. Alternatively the slide member 360 may be attached to the seal member 350 in the case that the seal member 350 is configured to be fixed within the bearing fitting portion 18.

This invention claims:

1. A flow control valve comprising:
a flow path defining member having a flow path defined therein;
a pair of bearing fitting portions formed on the flow path defining member and each having an inner circumferential face;
a valve member including:
a pair of valve shaft portions each having an axis and an outer circumferential face, each of the valve shaft portions being rotatably supported by each of the bearing fitting portions via a bearing; and
a valve body portion rotatable with the valve shaft portions capable of opening and closing the flow path;
an annular space defined between the at least one of the bearing fitting portions and the corresponding valve shaft portion opposed to each other in a radial direction with respect to the axis and between an end face of the corresponding bearing and an end face of the valve body portion opposed to each other in a direction of the axis;
a seal member disposed within the annular space and including a first seal portion configured to seal against the inner circumferential face of at least one of the bearing fitting portions, a second seal portion configured to seal against the outer circumferential face of the corresponding valve shaft portion, and a third seal portion configured to seal against the end face of the valve body portion.

2. The flow control valve as in claim 1, wherein the seal member is attached to the corresponding valve shaft portion of the valve member.

3. The flow control valve as in claim 1, wherein the seal member is attached to at least one of the bearing fitting portions of the flow path defining member.

4. The flow control valve as in claim 2, wherein the seal member is resiliently deformable and is resiliently fitted to the corresponding valve shaft portion of the valve member.

5. The flow control valve as in claim 4, further comprising an annular member attached to the seal member for restricting the resilient deformation with respect to the radial direction of the seal member.

6. The flow control valve as in claim 5, wherein the annular member has a contact part that can resiliently contact the outer circumferential face of the corresponding valve shaft portion.

7. The flow control valve as in claim 3, wherein the seal member is resiliently deformable and is resiliently fitted to at least one of the bearing fitting portions of the flow path defining member.

8. The flow control valve as in claim 7, further comprising an annular member attached to the seal member for restricting the resilient deformation with respect to the radial direction of the seal member.

9. The flow control valve as in claim 8, wherein the annular member has a contact part that can resiliently contact the inner circumferential face of at least one of the bearing fitting portions.

10. A flow control valve comprising:
a flow path defining member having a flow path defined therein;
a pair of bearing fitting portions formed on the flow path defining member and each having an inner circumferential face;
a valve member including:
a pair of valve shaft portions each having an axis and an outer circumferential face, each of the valve shaft portions being rotatably supported by each of the bearing fitting portions via a bearing.; and
a valve body portion rotatable with the valve shaft portions capable of opening and closing the flow path;
an annular space defined between the at least one of the bearing fitting portions and the corresponding valve shaft portion opposed to each other in a radial direction with respect to the axis and between an end face of the corresponding bearing and an end face of the valve body portion opposed to each other in a direction of the axis;
a seal member disposed within the annular space and including a press-fitting member and a resilient member;
the press-fitting member being press-fitted to one of the inner circumferential face of at least one of the bearing fitting portions and the outer circumferential face of the corresponding valve shaft portion; and
the resilient member comprising a first seal portion capable of sealing against the end face of the valve body portion and a second seal portion for sealing against the other of the inner circumferential face of the at least one of the bearing fitting portions and the outer circumferential face of the corresponding valve shaft portion;
the press-fitting member and the resilient member being integrated with each other.

11. The flow control valve as in claim 10, wherein the press-fitting member comprises a contact part that can resiliently contact one of the inner circumferential face of at least one of the bearing fitting portions and the outer circumferential face of the corresponding valve shaft portion.

12. The flow control valve as ii claim 1, wherein the seal member further comprises at least one of a positive-pressure receiving lip and a negative-pressure receiving lip, wherein the positive-pressure receiving lip can resiliently deform to increase the contact pressure due to a negative pressure when the negative pressure is created within the flow path, and wherein the positive-pressure receiving lip can resiliently deform to increase the contact pressure due to a positive pressure when the positive pressure is created within the flow path.

13. The flow control valve as in claim 10, wherein the seal member further comprises at least one of a positive-pressure receiving lip and a negative-pressure receiving lip, wherein the positive-pressure receiving lip can resiliently deform to increase the contact pressure due to a negative pressure when the negative pressure is created within the flow path, and wherein the positive-pressure receiving lip can resiliently deform to increase the contact pressure due to a positive pressure when the positive pressure is created within the flow path.

14. The flow control valve as in claim 1, further comprising a second seal member positioned on a side of the corresponding bearing and comprising a third sealing portion for sealing against the inner circumferential face of at least one of the bearing fitting portions and a fourth sealing portion for sealing against the outer circumferential face of the valve shaft portion.

15. The flow control valve as in claim 10, further comprising a second seal member positioned on a side of the corresponding bearing and comprising a third sealing portion for sealing against the inner circumferential face of at least one of the bearing fitting portions and a fourth sealing portion for sealing against the outer circumferential face of the valve shaft portion.

16. The flow control valve as in claim 14, wherein the second seal member further comprises at least one of a positive-pressure receiving lip and a negative-pressure receiving lip, wherein the positive-pressure receiving lip can resiliently deform to increase the contact pressure due to a negative pressure when the negative pressure is created within the flow path, and wherein the positive-pressure receiving lip can resiliently deform to increase the contact pressure due to a positive pressure when the positive pressure is created within the flow path.

17. The flow control valve as in claim 15, wherein the second seal member further comprises at least one of a positive-pressure receiving lip and a negative-pressure receiving lip, wherein the positive-pressure receiving lip can resiliently deform to increase the contact pressure due to a negative pressure when the negative pressure is created within the flow path, and wherein the positive-pressure receiving lip can resiliently deform to increase the contact pressure due to a positive pressure when the positive pressure is created within the flow path.

18. The flow control valve as in claim 1, further comprising a slide member interleaved between the end face of the valve body portion and a third seal portion and slidably contacting the end face of the valve body portion.

19. The flow control valve as in claim 10, further comprising a slide member interleaved between the end face of the valve body portion and a second seal portion and slidably contacting the end face of the valve body portion.

20. The flow control valve as in claim 18, wherein the slide member is integrated with the seal member.

21. The flow control valve as in claim 19, wherein the slide member is integrated with the seal member.
